(19) United States
(12) Patent Application Publication
(10) Pub. No.: US 2023/0100303 A1
(43) Pub. Date: Mar. 30, 2023

(54) FRACTIONAL INFERENCE ON GPU AND CPU FOR LARGE SCALE DEPLOYMENT OF CUSTOMIZED TRANSFORMERS BASED LANGUAGE MODELS

(71) Applicant: Oracle International Corporation, Redwood Shores, CA (US)

(72) Inventors: Siddhant Jain, Bangalore (IN); Saransh Mehta, Navi Mumbai (IN); Shahid Reza, Bengaluru (IN)

(73) Assignee: Oracle International Corporation, Redwood Shores, CA (US)

(21) Appl. No.: 17/488,289

(22) Filed: Sep. 28, 2021

(51) Int. Cl. G06N 3/04; G06K 9/62

(52) U.S. Cl. CPC G06N 3/0454; G06K 9/6267; G06F 15/78

(57) ABSTRACT

Systems and methods for fractional inference on GPU and CPU for large scale deployment of customized transformers based language models are disclosed herein. The method can include, receiving data for use in generation of a machine learning model output, ingesting the data with a first machine learning model on a Graphic Processing Unit, receiving at least one intermediate output from the first machine learning model at a temporary store, receiving the at least one intermediate output from the temporary store at a Central Processing Unit, ingesting the at least one intermediate output with a second machine learning model on the Central Processing Unit, and outputting a prediction with the second machine learning model.

### CROSS-REFERENCES TO RELATED APPLICATIONS

The present application is related to U.S. application Ser. No. 17/399,911, filed on Aug. 11, 2021, and entitled “System And Method For Implementing Federated Learning Engine For Integration Of Vertical And Horizontal AI”, the entirety of which is hereby incorporated by reference herein.

### BACKGROUND

Artificial relates to computer systems able to perform tasks that normally require intelligence, such as human intelligence. These tasks can include visual perception, speech recognition, decision-making, translation, or the like. Machine learning is a subset of artificial intelligence. Machine learning algorithms can improve automatically through experience and by the use of data.

### BRIEF SUMMARY

One aspect of the present relates to a method including receiving data for use in generation of a machine learning model output, ingesting the data with a first machine learning model on a Graphic Processing Unit (“GPU”), receiving at least one intermediate output from the first machine learning model at a temporary store, receiving the at least one intermediate output from the temporary store at a Central Processing Unit (“CPU”), ingesting the at least one intermediate output with a second machine learning model on the CPU, and outputting a prediction with the second machine learning model.

In some embodiments, the first model includes a first neural network, and the second model includes a second neural network. In some embodiments, the first neural network can be a deep learning neural network. In some embodiments, the deep learning neural network can be a transformer, and in some embodiments, the transformer can be a Bidirectional Encoder Representations from Transformers (“BERT”) model. In some embodiments, the second machine learning model can be a task specific model.

In some embodiments, the at least one intermediate output can include a plurality of intermediate outputs, each of the plurality of intermediate outputs generated by a unique layer of the first machine learning model. In some embodiments, an intermediate output is received at the CPU from the temporary store for each of the second layers of the second machine learning model. In some embodiments, the method includes identifying a next layer in the second model, receiving the intermediate output corresponding to the next layer, and generating a layer output of the identified next layer based at least in part on the corresponding intermediate output. In some embodiments, the method includes identifying at least one previous layer in the second model; and receiving a layer output of the identified at least one previous layer.

In some embodiments, receiving the layer output of the at least one previous layer includes receiving the layer output of the layer immediately preceding the identified next layer. In some embodiments, receiving the layer output of the at least one previous layer includes receiving the layer output of the two layers immediately preceding the identified next layer. In some embodiments, the method includes combining the intermediate output corresponding to the next layer and the layer output of the identified at least one previous layer. In some embodiments, generating the layer output of the identified next layer based at least in part on the corresponding intermediate output includes generating the layer output based on the combined intermediate output corresponding to the next layer and the layer output of the identified at least one previous layer.

In some embodiments, the method includes receiving the layer output of a last layer in the second model, and ingesting the layer output of the last layer into a classifier head. In some embodiments, the method includes generating the output prediction with the classifier head based on the ingested layer output of the last layer. In some embodiments, the method includes receiving the at least one intermediate output from the temporary store at a second Central Processing Unit (“second CPU”), ingesting the at least one intermediate output with a third machine learning model on the second CPU, and outputting a prediction with the third machine learning model. In some embodiments, the third machine learning model includes only a classifier head.

One aspect relates to a system. The system includes a memory including a temporary store, a Graphics Processing Unit machine running a first machine learning model, and a Central Processing Unit machine running a second machine learning model. In some embodiments, the Graphics Processing Unit machine can receive data for use in generation of a machine learning model output, ingest the data with the first machine learning model, generate at least one intermediate output from the first machine learning model, and provide the at least one intermediate output to the temporary store. In some embodiments, the Central Processing Unit machine can receive the at least one intermediate output from the temporary store, ingest the at least one intermediate output with the second machine learning model, and output a prediction with the second machine learning model.

One aspect of the present disclosure relates to a non-transitory computer-readable storage medium storing a plurality of instructions executable by one or more processors. The plurality of instructions when executed by the one or more processors cause the one or more processors to receive data for use in generation of a machine learning model output, ingest the data with a first machine learning model on a Graphic Processing Unit machine, receive at least one intermediate output from the first machine learning model at a temporary store, receive the at least one intermediate output from the temporary store at a Central Processing Unit machine, ingest the at least one intermediate output with a second machine learning model on the Central Processing Unit machine, and output a prediction with the second machine learning model.

### BRIEF DESCRIPTION OF THE DRAWINGS

FIG. 1 is a schematic depiction of one embodiment of a fractional inference system.

FIG. 2 is a schematic illustration of one embodiment of a computing environment for use of the fractional inference system.

FIG. 3 is a schematic illustration of machine learning modules within the fractional inference system.

FIG. 4 is a schematic depiction of one embodiment of the processing of a block within a second machine learning model.

FIG. 5 is a flowchart illustrating one embodiment of a process for fractional inference generation.

FIG. 6 is a flowchart illustrating one embodiment of a process for block operation within the second model.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Improvements and developments in machine learning have led to increased demands of hardware performance. For example, Deep Learning models can utilize extensive hardware to function effectively. This can include demands for higher performing Graphics Processing Unit machines (“GPU”) over standard Central Processing Unit machines (“CPU”). A GPU, or in other words, a Graphics Processing Unit machine can include one or several Graphics Processing Units. A CPU, or in other words, a Central Processing Unit machine can include one or several Central Processing Units.

Transformers based language models can be used to build language services. However, use of a transformer based language model can be subject to certain infrastructure and/or latency constraints. For example, high performing implementations may traditionally necessitate processing with a GPU. However, use of a GPU can be relatively expensive, and, because of the number of requests for use of a GPU can be large, a GPU may only have limited availability. Thus, while the GPU may be able to quickly process a request, because of the limited availability, there can be delays in receiving the requested processing. Further, demands for GPU based machines can create infrastructure constraints on the use of transformer based language models.

Some embodiments of the present application address this constraints via combined use of a first model and a second model in generating an output from a machine learning model. Each of the first and second models can include one or more layers, and the second model can include a classifier head. The first model can run on a GPU, and the second model can run on a CPU.

Data can be provided to the first model, which data can be ingested by the first model on the GPU. This first model can include a plurality of layers, and one or several intermediate outputs can be collected from the first model. In some embodiments, each intermediate output is an output of one of the layers in the first model. In some embodiments, the first model does not include a classifier head, and thus the first model cannot generate a final output, but can rather only generate intermediate outputs.

These intermediate outputs are stored in a temporary memory, and are then received and/or retrieved by the CPU. The intermediate outputs are provided to the second model running on the CPU, where there are ingested by an associated layer. The second model, based on the intermediate outputs, generates an output, which output can be provided.

The utilisation of both a GPU and a CPU decreases constraints due to both infrastructure and latency. Specifically, the intermediate outputs of the first model, and thus of the GPU, can be stored in the temporary store, which outputs can be accessed by a plurality of CPU models, thereby shifting significant workload from the GPU to the CPU. This decreases latency and decreases risk of infrastructure constraints.

One implementation utilized a hybrid approach utilising the GPU and the CPU for inference as discussed above. The embodiment includes a single transformers based language model, which can be a BERT model, hosted on the GPU and lightweight task specific model hosted on the CPU. This lightweight, task specific model can be trained using the transformers base model encodings. In some embodiments, multiple such task specific models can be trained using the encodings of single transformers based model to perform different tasks.

In addition to resolving issues with latency and infrastructure constraints, this hybrid approach improves the performance of the machine learning models. Specifically, catastrophic forgetting a frequently observed during fine-tuning of transformer based language models. This can occur when, during task specific fine tuning, the model forgets its generalization and inclines towards the specific task for which it is being fine-tuned. This limits the models ability to be used for other tasks as well. The hybrid approach addresses this problem by freezing the language model (BERT in our case) weights while training the task specific model. Hence the same BERT model can be used for multiple tasks by training their respective task specific model only. The task specific model can be built by stacking blocks where a block is formed with consecutive down and up projection of the inputs. The number of blocks in task specific model can be equal to the number of encoder layers/blocks present in the transformer based model being used. For example, in the first model includes 12 encoder layers, the second model could include 12 blocks.

Placing the first model, which can be a transformer based model, and the second model, which can be a task specific model, on different devices (the GPU and the CPU respectively) poses challenges in connecting the two models while making a complete forward pass for inference. The hybrid model disclosed herein connects the first and second models, and thus the GPU and the CPU by storing the output encodings, referred to herein as intermediate outputs, of the transformer based model while making the forward pass through it. These intermediate outputs can be stored in a temporary store, which can be accessible by the CPU and the second model. When making the forward pass through task specific model, the stored encodings are fetched and transferred to the CPU device which is then consumed block-wise by task specific model.

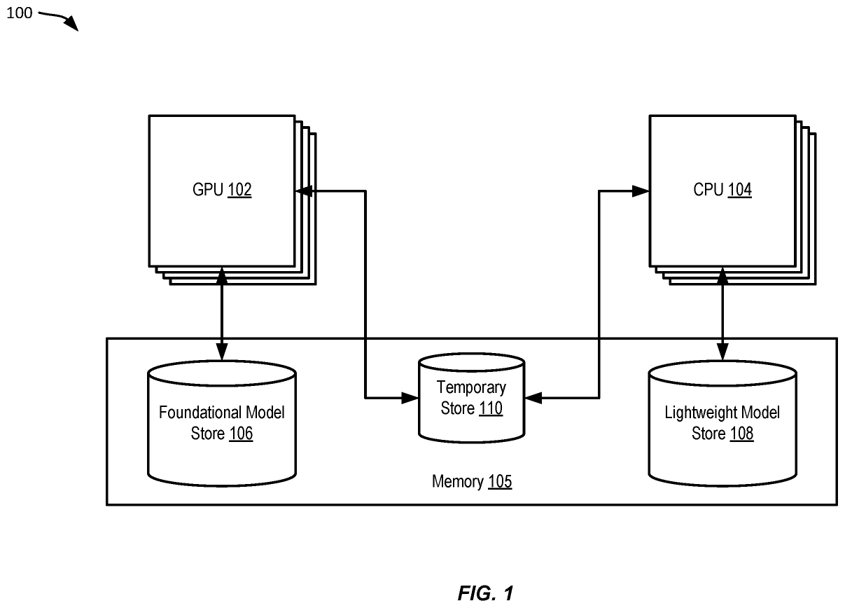

With reference now to FIG. 1, a schematic depiction of one embodiment of a fractional inference system 100 is shown. The fractional inference system 100 can include a GPU 102 and a CPU 104. The GPU 102 can be any GPU capable of and/or configured for use with a machine learning model. In some embodiments, the GPU can comprise, for example, a Nvidia V100 GPU. The CPU 104 can be any CPU capable and/or configured for use with a machine learning model. In some embodiments, the CPU 104 can comprise for example, a CPU manufactured by Intel or AMD such as, for example, a AMD Ryzen.

In some embodiments, the fractional inference system 100 can include a single GPU 102 or can include a plurality of GPUs 102. Likewise, in some embodiments, the fractional inference system 100 can include a single CPU 104 or can include a plurality of CPUs 104. In some embodiments, the fractional inference system 100 can include more CPUs 104 than GPUs 102. In one embodiment, for example, a single GPU 102 may be communicatingly coupled with a plurality of CPUs 104 such as, for example, a single GPU 102 communicatingly coupled with 2, 3, 4, 5, 6, 7, 8, 9, 10, 15, 20, 50, 100, or any other or intermediate number of CPUs 104. In some embodiments, the one or several GPUs 102 and the one or several CPUs 104 can be located within a single host machine.

The fractional inference system 100 can include memory 105. Memory 105 can comprise hardware and software components used for storing data and program instructions, such as system memory and computer-readable storage media. The system memory and/or computer-readable storage media may store program instructions that are loadable and executable on GPU 102 and/or on CPU 104, as well as data generated during the execution of these programs. Memory 105 can include, in some embodiments, a foundation model store 106 and/or a lightweight model store 108. In some embodiments, memory 105 can comprise a single memory comprising both the foundation model store 106 and the lightweight model store 108, and in some embodiments, memory 105 can comprise multiple memories, one of which can comprise all or portions of the foundational model store 106, and another of which can comprise all or portions of the lightweight model store 108. Thus, in some embodiments, the foundational model store 106 and the lightweight model store 108 can reside in different hardware within the fractional inference system 100.

The GPU 102 can be communicatingly coupled with the foundational model store 106, also referred to herein as a first model store 106. The first model store 106 can store the foundational machine learning model, also referred to herein as a first machine learning model, run on the GPU 102. The first machine learning model can comprise, for example, a neural network. In some embodiments, the neural network of the first model can comprise, for example, a deep learning neural network. In some embodiments, the deep learning neural network can comprise a transformer, which transformer can comprise a Bidirectional Encoder Representations from Transformers (“BERT”) model. In some embodiments, the first model comprises a single transformers based language model, which can be a BERT model. In some embodiments, the first model does not include a classifier head.

The first model can be configured and/or trained as a feature extractor. In some embodiments, the first model can be configured to generate one or several output encodings, also referred to herein as one or several intermediate outputs. In some embodiments, each intermediate output is an output of one of the layers in the first model. In some embodiments, some or all of the layers in the first model each generates an intermediate output.

The CPU 104 can be communicatingly coupled with the lightweight model store 108, also referred to herein as the second model store 108. The second model store 108 can store the lightweight machine learning model, also referred to herein as the second model, the second machine learning model and/or the task specific machine learning model. The second model can be run on the CPU 104.

The second model can comprise a plurality of stacked blocks, wherein each block is formed with consecutive down and up projection of the inputs to that block. The number of blocks in second model can, in some embodiments, be equal to the number of encoder layers/blocks present in the first model being used. In some embodiments, when making the forward pass through second model, the stored intermediate outputs are fetched and transferred to the CPU 104, and these intermediate outputs are then consumed block-wise by the second model.

The GPU 102 and the CPU 104 can be communicatingly coupled via the temporary store 110. The temporary store 110 can store intermediate outputs of the GPU 102. The temporary store 110 can be a part of memory 105, or can comprise distinct physical and/or software components. In some embodiments, the temporary store 110 can receive intermediate outputs from the GPU 102, and can store those outputs, for example, for a predetermined time, until they are retrieved by one or several CPUs 104, or until they are replaced by new intermediate outputs from the GPU. The intermediate outputs can be retrieved from the temporary store 110 by one or several CPUs 104 and/or by one or several second models.

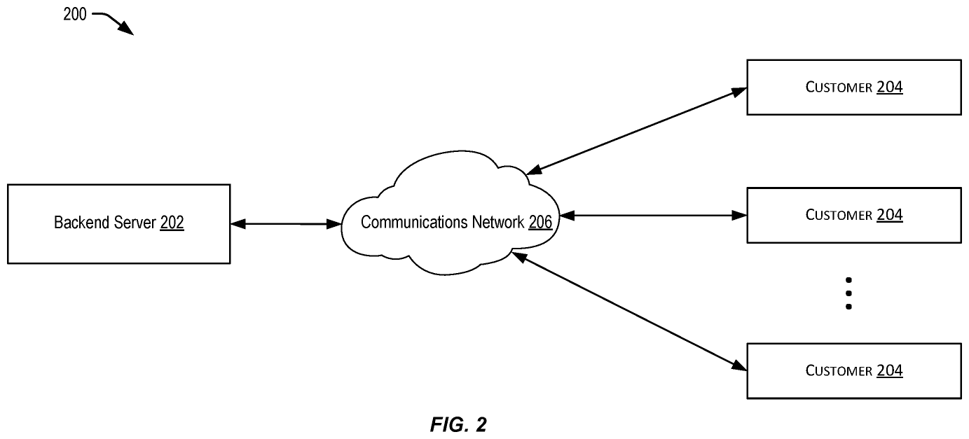

With reference now to FIG. 2, a schematic illustration of one embodiment of a computing environment 200 for use of the fractional inference system 100 is shown. The computing environment can include one or several backend servers 202 communicatingly coupled with one or several customer servers 204 and/or customer computers 204 via a communications network 206. In some embodiments, the entirety of the fractional inference system 100 can be located in the backend server 202, and in some embodiments, all or portions of the fractional inference system 100 can be split between components of the computing environment 200. In some embodiments, for example, the GPU 102 can be located in the backend server 202, and the CPU 104 can be located in the customer server 204. Regardless of the location of specific components of the fractional inference system 100, the one or several GPUs 102 of the fractional inference system 100 communicate intermediate outputs to one or several CPUs 104 via the temporary store 110.

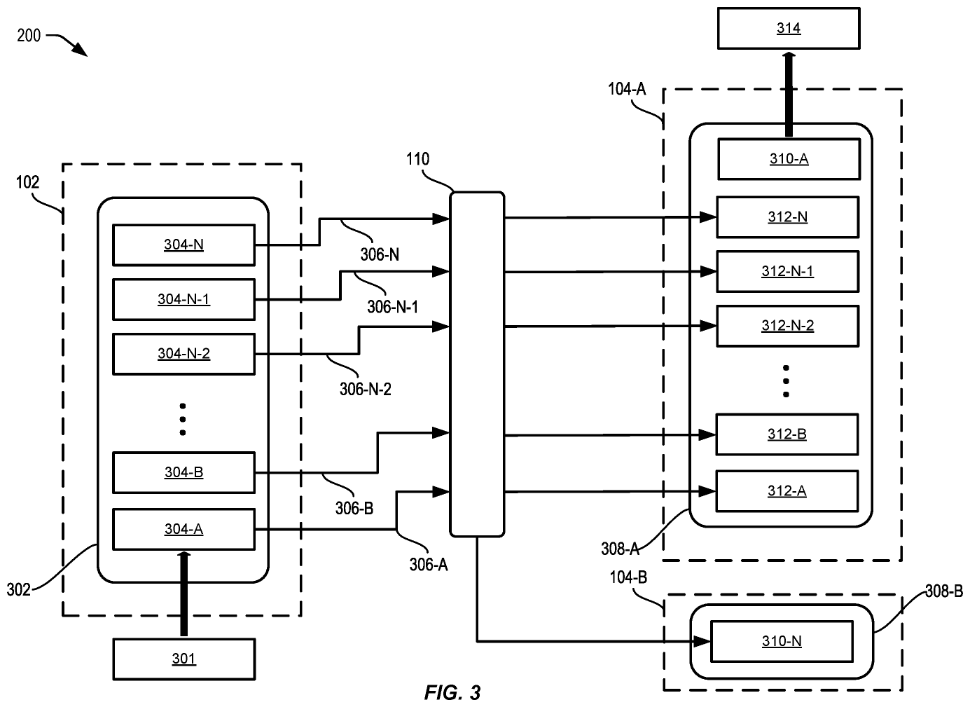

With reference now to FIG. 3, a schematic illustration of machine learning modules 300 within the fractional inference system 100. As depicted, the fractional inference system 100 includes the GPU 102 and the CPU 104, which are coupled via the temporary store 110. The GPU 102 includes the first model 302, which includes a plurality of encoder layers 304, also referred to herein as encoder blocks 304 or layers 304. The GPU 102 receive an input 301, which is ingested by the first model 302. The first model 302, can be trained for feature extraction. In some embodiments, the first model can be pre-trained for feature extraction, and the pre-trained first model can be frozen and thus can remain constant. A plurality of intermediate outputs 306 can be generated by the layers 304 of the first model 302. In some embodiments, each of the encoder block 304 of the first model 302 can generate an intermediate output 306. The intermediate output 306 can be provided to the temporary store 110 by the GPU 102 and/or by the first model 302, and can be stored by the temporary store 110.

The temporary store 110 can be coupled to one or several CPUs 104 each of which can include or run one or several second models 308. These second models 308 can be lightweight, task specific models. Each of the second models 308 can comprise at least a classifier head 310. In some embodiments, the second model 308 can comprise only a classifier head 310, such as shown with second model 308-B, which can receive intermediate outputs 306 from the temporary store 110 and can generate and output a prediction. In some embodiments, the second model 308 can comprise one or several blocks 312, such as shown with second model 308-A, which can be stacked. In some embodiments, each block 312 can be formed with consecutive down and up projection of received inputs. In embodiments in which the second model 308 comprises a plurality of blocks 312, the output of the final block 312-N can be provided to a classifier head 310-A, which can generate and output a prediction 314 based on that, and any other, received inputs.

In some embodiments, and as shown in FIG. 3, each of the blocks 312 of the second model 308-A can receive and/or ingest an associated intermediate output from the first model 302 via the temporary store 110. In some embodiments, a first layer 304-A in the first model 302 can generate a first intermediate output 306-A, which can be associated with a first block 312-A in the second model 308. This correspondence between blocks 312 in the second model 308 to layers 304 in the first model 302 can continue, such that a second intermediate output 306-B of a second layer 304-B of the first model 302 corresponds with the second block 312-B in the second model 308, and on such that an Nth intermediate output 306-N of an Nth layer 304-N in the first model 302 corresponds an Nth block 312-N in the second model 308.

In some embodiments, a first, second model 308-A can receive the intermediate outputs 306 from the temporary store 110 and can generate an output 314 based on those inputs. This first, second model 308-A can be located, run, and/or running on a first CPU 104-A. In some embodiments, a second, second model 308-B can receive the intermediate outputs 306 from the temporary store 110. The second, second model 308-B can, like the first, second model 308-A, comprise a lightweight, task specific model. In some embodiments, the first, second model 308-A can be trained for a first task, and the second, second model 308-B can be trained for a second task. The second, second model 308-B can be located, running, and/or run on the same CPU 104 as the first, second model 308-A, or can be located and/or run on a different CPU 104 than the first, second model 308-A. Thus, in some embodiments, the second, second model 308-B can be located, run, and/or running on a second CPU 104-B.

In some embodiments, the second, second model 308-B can comprise the same number of blocks 312 as the first, second model 308-A, and in some embodiments, the second, second model 308-B can comprise a different number of blocks 312 than the first, second model 308-A. In some embodiments, the second, second model 308-A can comprise the same number of blocks 312 as the number of layers 304 in the first model 302 and/or as the number of intermediate outputs 306 generated by the first model 302. In some embodiments, the second, second model 308-B can comprise only a classifier head.

In some embodiments, the second, second model 308-B can receive at least one intermediate output 306 from the temporary store, and can ingest that at least one intermediate output 306. In some embodiments, the second, second model 308-B can receive these intermediate outputs 306 via the CPU 104 on which the second, second model 308-B runs. In some embodiments, this CPU 104 can be a second CPU 104-B. The second, second model 308-B can process the at least one intermediate output 306 as outlined below, and can, output a prediction 314.

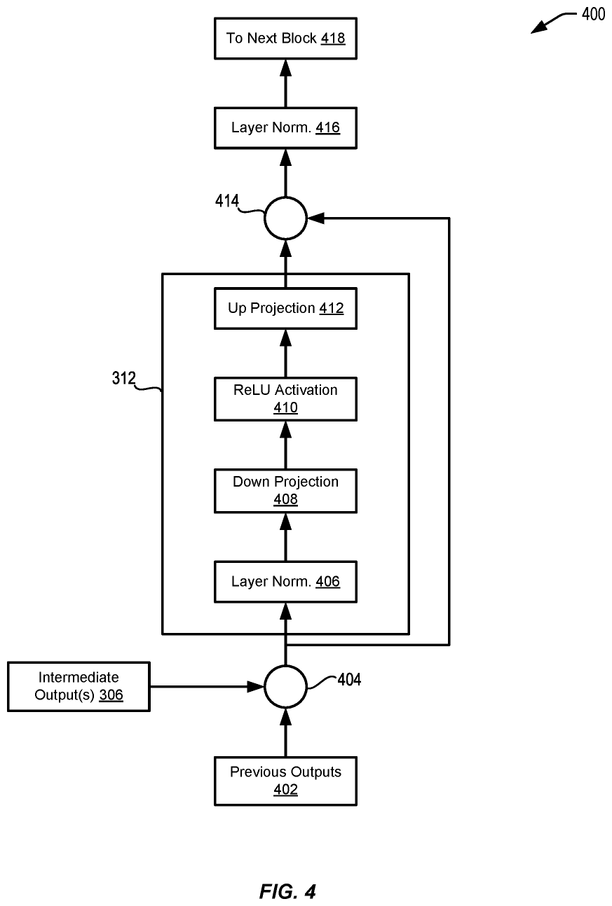

With reference now to FIG. 4, a schematic depiction of one embodiment of the processing 400 of a block 312 of the second model is shown. As indicated at 402, outputs from one or several previous blocks 312 in the second model 308 are identified and received. This previous outputs can include the outputs of the block 312 immediately previous to the block 312 shown in FIG. 4, or can include the outputs of a plurality of blocks 312 previous to the block 312 shown in FIG. 4 including, for example, the outputs of the two blocks 312 immediately previous to the block 412 shown in FIG. 4.

As indicated in block 306, one or several intermediate outputs are received. These can include, for example, the intermediate output associated with the block 312 shown in FIG. 4. In some embodiments, these intermediate outputs 306 can further include, for example, one or several intermediate outputs 306 associated with one or several blocks 312 previous to, and more specifically, immediately previous to the block 312 shown in FIG. 4. In some embodiments, these one or several intermediate outputs 306 associated with one or several blocks 312 previous to the block 312 shown in FIG. 4 includes the intermediate output of one or both of the two blocks 312 immediately previous to the block 312 shown in FIG. 4.

The intermediate output 306 and the previous outputs 402 can be ingested into the block 312 shown in FIG. 4, and/or can be combined at 404, and then ingested into the block 312 shown in FIG. 4. The inputs to the block 312 can be passed through layer normalization 406, a down projection 408, ReLU activation 410, an up projection 412, and in some embodiments, an additional layer normalization 416. In some embodiments, the inputs to the block 312 can be passed through a ReLU activated down projection, an up projection, and finally passed through layer normalization. In some embodiments, the ReLU activated down projection can have a linear layer of size 64, and the up projection can have a linear layer of size that is the same as the inputs.

In some embodiments, the output of the block 312 can be combined with the inputs to the block 312 at 414 as a residual connection. These combined inputs/outputs can be passed through layer normalization 416, and then can be provided to the next block 312 as previous outputs 402.

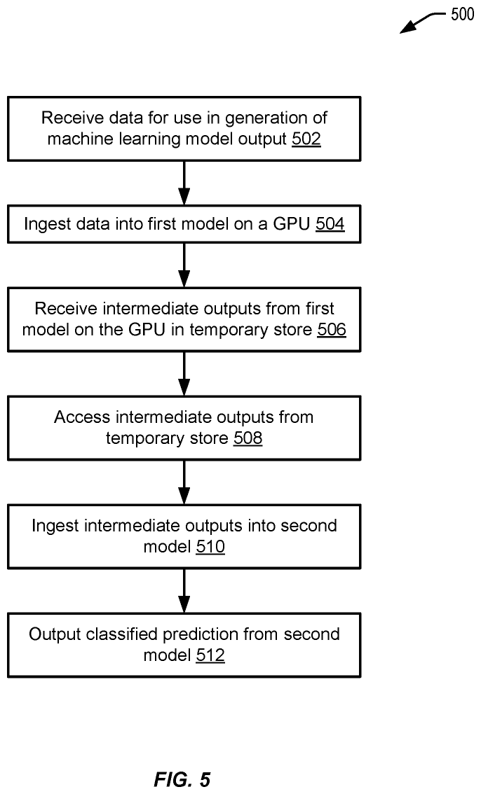

With reference now to FIG. 5, a flowchart illustrating one embodiment of a process 500 for fractional inference generation is shown. The process 500 can be performed by all or portions of the fractional inference system 100. The process 500 begins at block 502, wherein data for use in generation of a machine learning output is received. In some embodiments, this can correspond to receipt of input 301, and the data for use in generation of the machine learning output can be received at the GPU 102.

At block 504, the data received at block 502 is ingested into the first model 302 on the GPU 102. This first model is a machine learning model, and can comprise, for example, a first neural network, a first deep learning neural network, a transformer, and/or a BERT model.

Subsequent to ingestion of the input of block 301, the first model 302 generates at least one intermediate output 306. In some embodiments, each encoder layer 304 of the first model 302 generates an intermediate output 306, and provides this intermediate output 306 to the temporary store 110. Thus, a first model 302 having one encoder layer 304 can provide one intermediate output 306, whereas a first model 302 having a plurality of encoder layers 304 can generate a plurality of intermediate outputs 306. In some embodiments, each of the intermediate outputs is generated by a unique encoder layer 304 within the first model 302.

The intermediate outputs 306 are received from the first model 302 on the GPU 102 at the temporary store, and these intermediate outputs 306 are stored at the temporary store 110. In some embodiments, the intermediate outputs 306 can be provided to, and received by the temporary store as they are generated, or they can be provided one some or all of the intermediate outputs 306 have been generated.

At block 508 the at least one intermediate outputs 306 are accessed from the temporary store 110. In some embodiments, this can include the receiving and/or retrieving of the intermediate outputs 306 from the temporary store. In some embodiments, the at least one intermediate outputs 306 are received from the temporary store 110 at the CPU 104. In some embodiments, an intermediate outputs can be accessed, and specifically can be received and/or retrieved by the CPU for each layer 312 in the second model 308.

At block 510, the intermediate outputs 306 are ingested with the second model 308. The second model 308, which can include a neural network and/or a task specific model, can include a plurality of layers 312. In some embodiments, the second model 308 can include a same number of layers 312 as the number of layers 304 in the first model 302. In some embodiments, the second model 308 can include the same number of layers 312 as the number of intermediate outputs 306 generated by the second model 308. In some embodiments, the second model 308 can comprise the classifier head 310. In some embodiments, the second model 308 can comprise the classifier head 310 in addition to the layers 312 of the second model 308, and in some embodiments, the second model 308 can comprise only the classifier head 310.

In some embodiments, the ingestion of the intermediate outputs with the second model 308 includes advancing through the layers 312 of the second model 308, and at each layer, identifying the intermediate output associated with that layer 312, and ingesting that intermediate output, along with any other outputs, into that layer 312. Upon advancing through all of the layers 312, the output of the layers 312 is provided to the classifier head 310.

At block 512, the second model 308 provides an output. In some embodiments, the output can comprise a classified prediction generated by the second model 308, and specifically by the classifier head 310 of the second model 308. In some embodiments, providing the output can include receiving the layer output of a last layer in the second model and ingesting the layer output of the last layer into the classifier head 310 of the second model 308. In some embodiments, providing the output can include generating the output prediction with the classifier head based on the ingested layer output of the last layer of the second model 308.

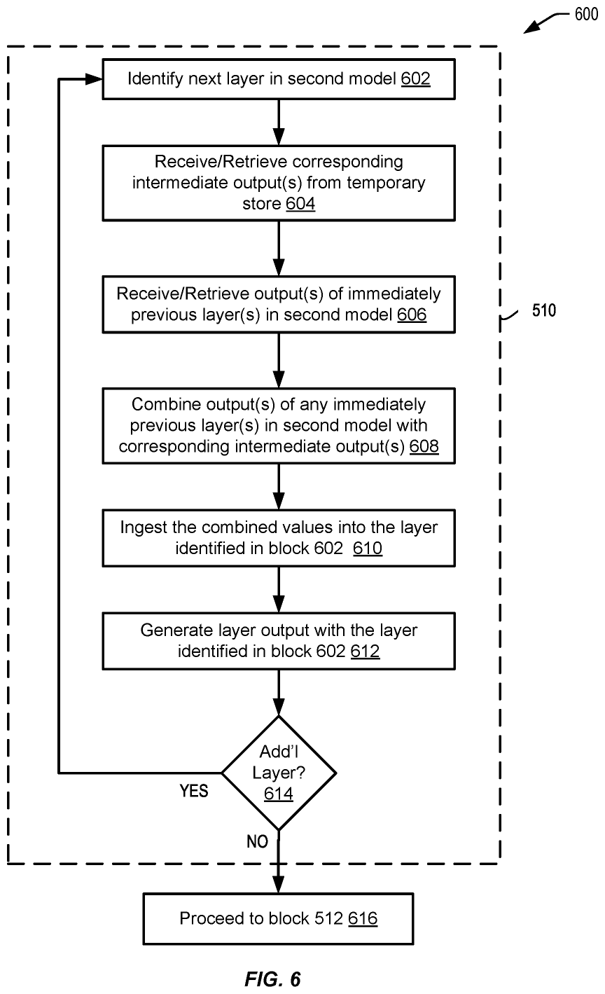

With reference now to FIG. 6, a flowchart illustrating one embodiment of a process 600 for block operation within the second model is shown. In some embodiments, the process 600 can be performed as a part of, or in the place of the step of block 510 of FIG. 5. The process 600 can be performed by the second model 308, and specifically by one block 312 of the second model 308. The process 600 can be iteratively performed for each of the blocks 312 in the second model 308.

The process 600 begins at block 602, wherein a next layer 312 in the second model is identified. In some embodiments, this next layer can comprise a first layer 312-A in the second model 308, and in some embodiments, this next layer 312 can comprise the next layer 312 in the second model 308 for which the processing of process 600 has not yet been performed. In some embodiments, identifying the next layer 312 in the second model 308 can further include identifying one or several previous layers 312 in the second model 308. These one or several identified previous layers can include, for example, a layer immediately preceding the next layer identified in block 602, the two layers immediately preceding the next layer identified in block 602, the three layers immediately preceding the next layer identified in block 602, or the like.

At block 604, one or several intermediate outputs 306 are received and/or retrieved. In some embodiments, this can include identifying an intermediate output 306 in the temporary store that corresponds to the next layer identified in block 602, and receiving and/or retrieving this intermediate output 306.

At block 606 outputs of immediately previous layers in the second model 308 are received. In some embodiments, these outputs are only received if the next layer identified in block 602 is preceded by one or several layers. In some embodiments, and if the next layer identified in block 602 is preceded by one or several layers, which one or several preceding layers can be identified in block 602, then outputs of some or all of the one or several preceding layers can be received and/or retrieved. In some embodiments, for example, receiving a layer output from the identified at least one preceding layer can include receiving the layer output of the layer immediately preceding the identified next layer. In some embodiments, receiving the layer output of the at least one previous layer comprises receiving the layer output of the two layers immediately preceding the identified next layer.

In some embodiments, the receiving the outputs of immediately preceding layers in the second model 308 can further include, for example, receiving the intermediate outputs corresponding to those one or several of those preceding layers. In some embodiments, receiving the layer output of the at least one previous layer can include, for example, receiving the intermediate output of the layer immediately preceding the next layer identified in block 602 and/or can include receiving the intermediate output of the two layers immediately preceding the identified next layer.

At block 608, any outputs of immediately previous layers received and/or retrieved in block 606 are combined with the intermediate output received and/or retrieved in block 604. In some embodiments, these outputs can be combined as indicated in 404 of FIG. 4. At block 610, the combined outputs, also referred to herein as the combined values, are ingested into the next layer 312 of the second model 308, which next layer 312 is identified in block 602. IN some embodiments, the combined values ingested into the next layer identified in block 602 can be the sum of the intermediate output from the corresponding BERT layer in the first model 303 and the output from the previous layer in the second model 308.

At block 612, a layer output is generated with the layer identified in block 602. In some embodiments, this layer output can be generated based at least in part on the corresponding intermediate output. In some embodiments, generating the layer output of the identified next layer based at least in part on the corresponding intermediate output can include generating the layer output based on the combined intermediate output corresponding to the next layer and the layer output of the identified at least one previous layer.

At block 614, it is determined if there is an additional layer 312 in the second model 308. If there is an additional layer, then the process 600 returns to block 602 and proceeds as outlined above. If there is no additional layer, then the process 600 proceeds to block 616 and returns to block 512 of FIG. 5.

### Example Implementation

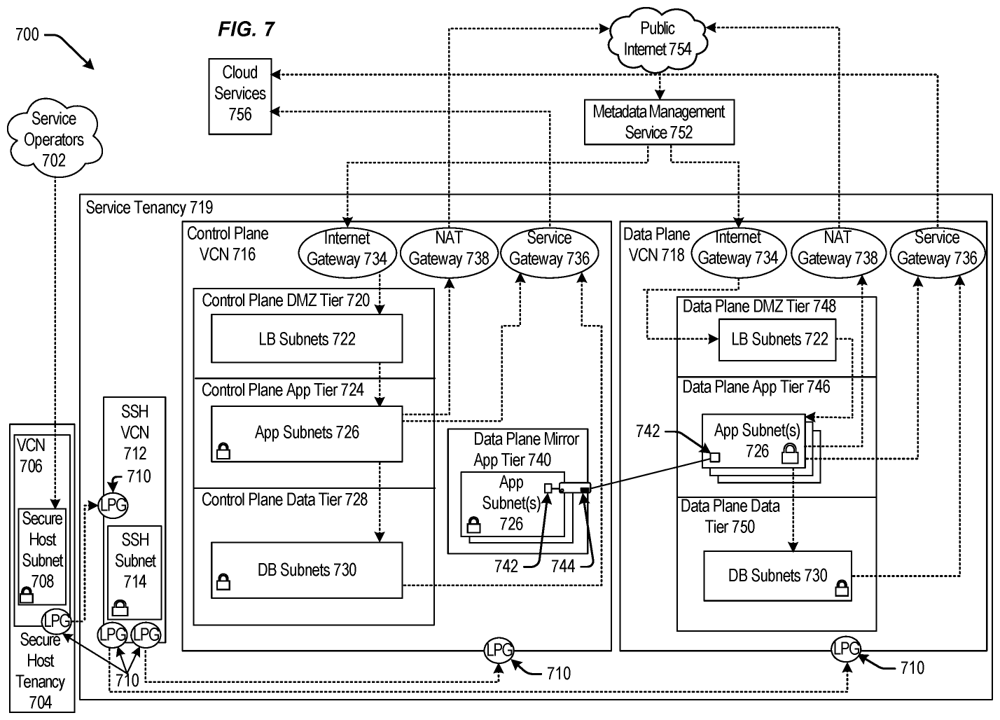

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 818 via an LPG 9710. The control plane VCN 816 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep security breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 818. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively couple to cloud services 756.

In some examples, the service gateway 736 of the control plane VCN 716 or of the data plan VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Memory that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 854, which may not have a desired level of security, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

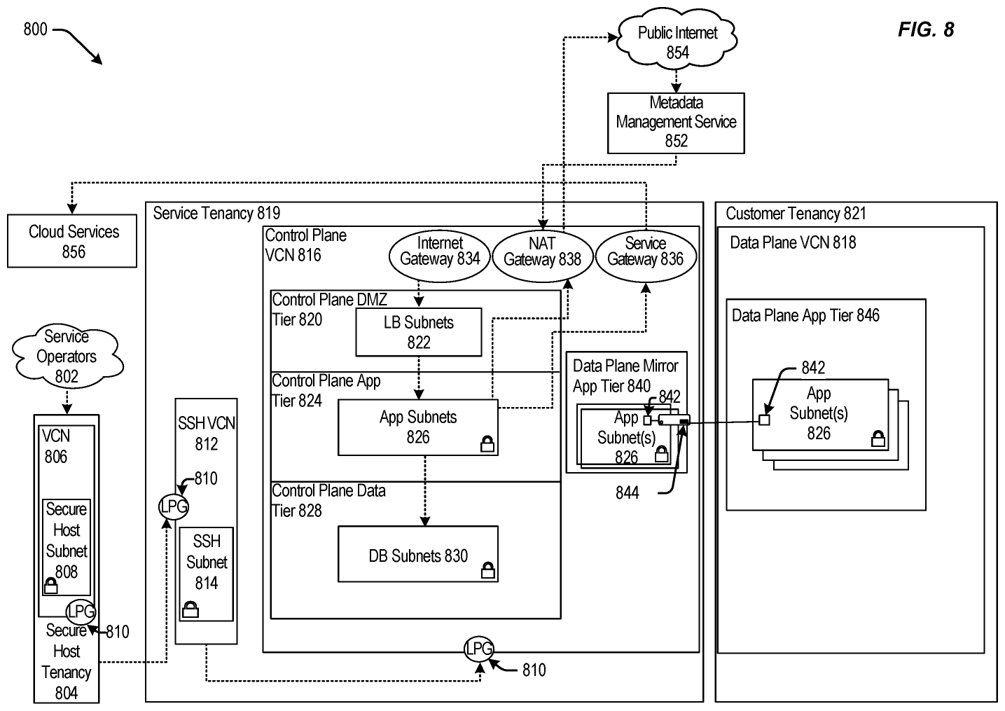

FIG. 8 is a block diagram 800 illustrating another example pattern of an IaaS architecture, according to at least one embodiment. Service operators 802 (e.g. service operators 702 of FIG. 7) can be communicatively coupled to a secure host tenancy 804 (e.g. the secure host tenancy 704 of FIG. 7) that can include a virtual cloud network (VCN) 806 (e.g. the VCN 706 of FIG. 7) and a secure host subnet 808 (e.g. the secure host subnet 708 of FIG. 7). The VCN 806 can include a local peering gateway (LPG) 810 (e.g. the LPG 710 of FIG. 7) that can be communicatively coupled to a secure shell (SSH) VCN 812 (e.g. the SSH VCN 712 of FIG. 7) via an LPG 710 contained in the SSH VCN 812. The SSH VCN 812 can include an SSH subnet 814 (e.g. the SSH subnet 714 of FIG. 7), and the SSH VCN 812 can be communicatively coupled to a control plane VCN 816 (e.g. the control plane VCN 716 of FIG. 7) via an LPG 810 contained in the control plane VCN 816. The control plane VCN 816 can be contained in a service tenancy 819 (e.g. the service tenancy 719 of FIG. 7), and the data plane VCN 818 (e.g. the data plane VCN 718 of FIG. 7) can be contained in a customer tenancy 821 that may be owned or operated by users, or customers, of the system.

The control plane VCN 816 can include a control plane DMZ tier 820 (e.g. the control plane DMZ tier 720 of FIG. 7) that can include LB subnet(s) 822 (e.g. LB subnet(s) 722 of FIG. 7), a control plane app tier 824 (e.g. the control plane app tier 724 of FIG. 7) that can include app subnet(s) 826 (e.g. app subnet(s) 726 of FIG. 7), a control plane data tier 828 (e.g. the control plane data tier 728 of FIG. 7) that can include database (DB) subnet(s) 830 (e.g. similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g. the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g. the service gateway of FIG. 7) and a network address translation (NAT) gateway 838 (e.g. the NAT gateway 738 of FIG. 7). The control plane VCN 816 can include the service gateway 836 and the NAT gateway 838.

The control plane VCN 816 can include a data plane mirror app tier 840 (e.g. the data plane mirror app tier 740 of FIG. 7) that can include app subnet(s) 826. The app subnet(s) 826 contained in the data plane mirror app tier 840 can include a virtual network interface controller (VNIC) 842 (e.g. the VNIC of 742) that can execute a compute instance 844 (e.g. similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g. the data plane app tier 746 of FIG. 7) via the VNIC 842 contained in the data plane mirror app tier 840 and the VNIC 842 contained in the data plan app tier 846.

The Internet gateway 834 contained in the control plane VCN 816 can be communicatively coupled to a metadata management service 852 (e.g. the metadata management service 752 of FIG. 7) that can be communicatively coupled to public Internet 854 (e.g. public Internet 754 of FIG. 7). Public Internet 854 can be communicatively coupled to the NAT gateway 838 contained in the control plane VCN 816. The service gateway 836 contained in the control plane VCN 816 can be communicatively couple to cloud services 856 (e.g. cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 11,” may be located in Region 1 and in “Region 2.” If a call to Deployment 11 is made by the service gateway 836 contained in the control plane VCN 816 located in Region 1, the call may be transmitted to Deployment 11 in Region 1. In this example, the control plane VCN 816, or Deployment 11 in Region 1, may not be communicatively coupled to, or otherwise in communication with, Deployment 11 in Region 2.

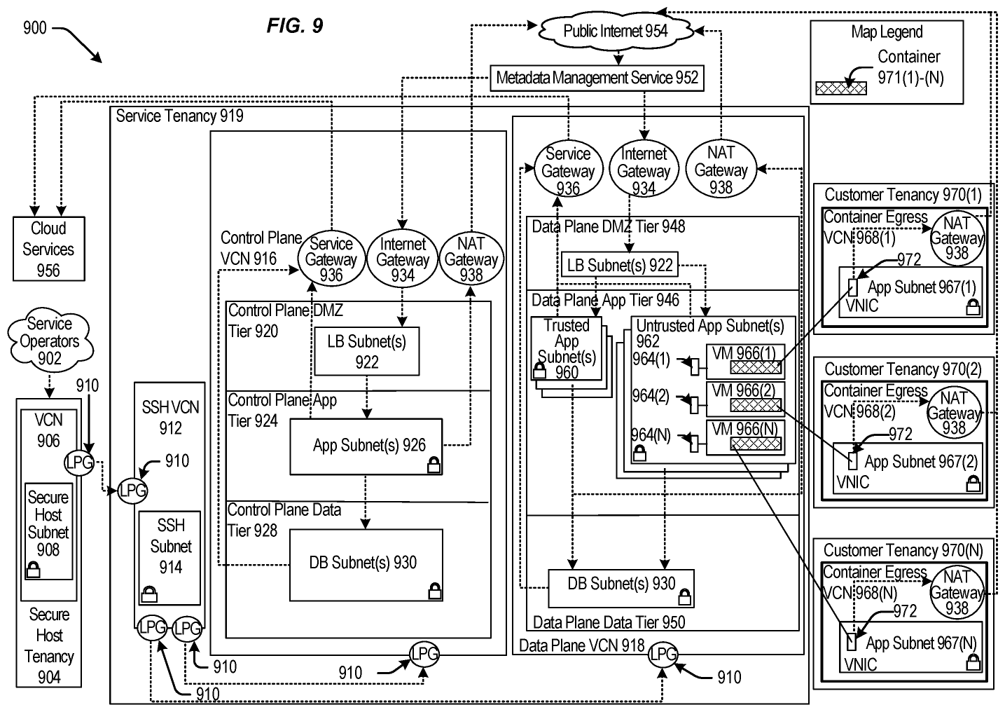

FIG. 9 is a block diagram 900 illustrating another example pattern of an IaaS architecture, according to at least one embodiment. Service operators 902 (e.g. service operators 702 of FIG. 7) can be communicatively coupled to a secure host tenancy 904 (e.g. the secure host tenancy 704 of FIG. 7) that can include a virtual cloud network (VCN) 906 (e.g. the VCN 706 of FIG. 7) and a secure host subnet 908 (e.g. the secure host subnet 708 of FIG. 7). The VCN 906 can include an LPG 910 (e.g. the LPG 710 of FIG. 7) that can be communicatively coupled to an SSH VCN 911 (e.g. the SSH VCN 712 of FIG. 7) via an LPG 910 contained in the SSH VCN 912. The SSH VCN 912 can include an SSH subnet 914 (e.g. the SSH subnet 714 of FIG. 7), and the SSH VCN 912 can be communicatively coupled to a control plane VCN 916 (e.g. the control plane VCN 716 of FIG. 7) via an LPG 910 contained in the control plane VCN 916 and to a data plane VCN 918 (e.g. the data plane 718 of FIG. 7) via an LPG 910 contained in the data plane VCN 918. The control plane VCN 916 and the data plane VCN 918 can be contained in a service tenancy 919 (e.g. the service tenancy 719 of FIG. 7).

The control plane VCN 916 can include a control plane DMZ tier 920 (e.g. the control plane DMZ tier 720 of FIG. 7) that can include load balancer (LB) subnet(s) 922 (e.g. LB subnet(s) 722 of FIG. 7), a control plane app tier 924 (e.g. the control plane app tier 724 of FIG. 7) that can include app subnet(s) 926 (e.g. similar to app subnet(s) 726 of FIG. 7), a control plane data tier 928 (e.g. the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g. the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g. the service gateway of FIG. 7) and a network address translation (NAT) gateway 938 (e.g. the NAT gateway 738 of FIG. 7). The control plane VCN 916 can include the service gateway 936 and the NAT gateway 938.

The data plane VCN 918 can include a data plane app tier 946 (e.g. the data plane app tier 746 of FIG. 7), a data plane DMZ tier 948 (e.g. the data plane DMZ tier 748 of FIG. 7), and a data plane data tier 950 (e.g. the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g. public Internet 754 of FIG. 7).

The Internet gateway 934 contained in the control plane VCN 916 and contained in the data plane VCN 918 can be communicatively coupled to a metadata management service 952 (e.g. the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

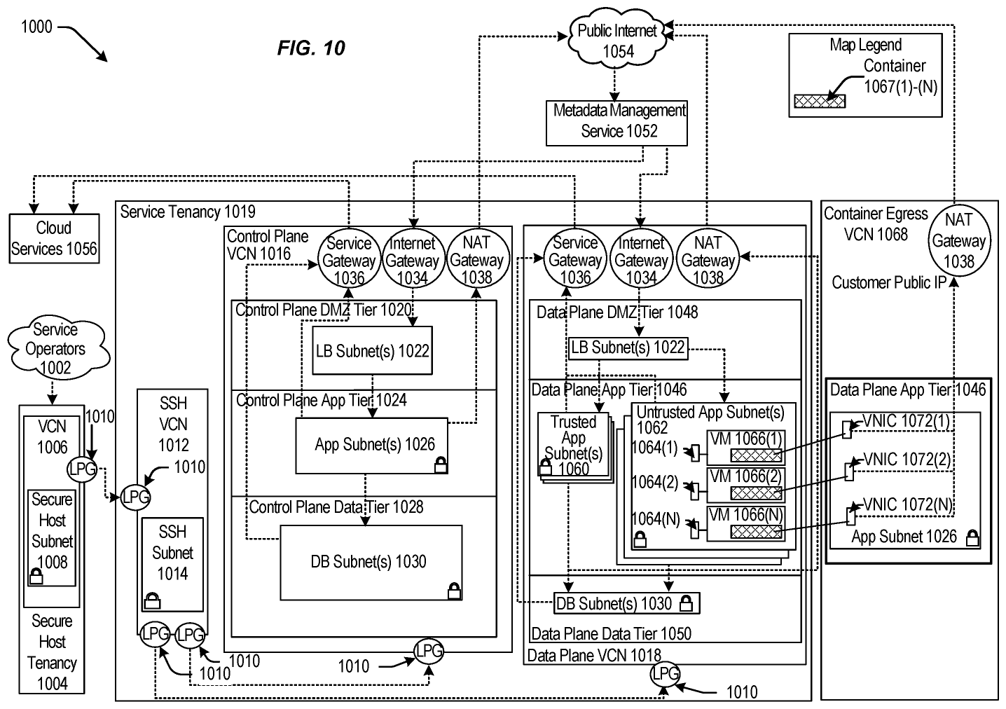

FIG. 10 is a block diagram 1000 illustrating another example pattern of an IaaS architecture, according to at least one embodiment. Service operators 1002 (e.g. service operators 702 of FIG. 7) can be communicatively coupled to a secure host tenancy 1004 (e.g. the secure host tenancy 702 of FIG. 7) that can include a virtual cloud network (VCN) 1006 (e.g. the VCN 706 of FIG. 7) and a secure host subnet 1008 (e.g. the secure host subnet 708 of FIG. 7). The VCN 1006 can include an LPG 1010 (e.g. the LPG 710 of FIG. 7) that can be communicatively coupled to an SSH VCN 111012 (e.g. the SSH VCN 712 of FIG. 7) via an LPG 1010 contained in the SSH VCN 111012. The SSH VCN 111012 can include an SSH subnet 1014 (e.g. the SSH subnet 714 of FIG. 7), and the SSH VCN 111012 can be communicatively coupled to a control plane VCN 1016 (e.g. the control plane VCN 716 of FIG. 7) via an LPG 1010 contained in the control plane VCN 1016 and to a data plane VCN 1018 (e.g. the data plane 716 of FIG. 7) via an LPG 1010 contained in the data plane VCN 1018. The control plane VCN 1016 and the data plane VCN 1018 can be contained in a service tenancy 1019 (e.g. the service tenancy 719 of FIG. 7).

The control plane VCN 1016 can include a control plane DMZ tier 1020 (e.g. the control plane DMZ tier 720 of FIG. 7) that can include LB subnet(s) 1022 (e.g. LB subnet(s) 722 of FIG. 7), a control plane app tier 1024 (e.g. the control plane app tier 724 of FIG. 7) that can include app subnet(s) 1026 (e.g. app subnet(s) 726 of FIG. 7), a control plane data tier 1028 (e.g. the control plane data tier 728 of FIG. 7) that can include DB subnet(s) 1030 (e.g. DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g. the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g. the service gateway of FIG. 7) and a network address translation (NAT) gateway 1038 (e.g. the NAT gateway 738 of FIG. 7). The control plane VCN 1016 can include the service gateway 1036 and the NAT gateway 1038.

The data plane VCN 1018 can include a data plane app tier 1046 (e.g. the data plane app tier 746 of FIG. 7), a data plane DMZ tier 1048 (e.g. the data plane DMZ tier 748 of FIG. 7), and a data plane data tier 1050 (e.g. the data plane data tier 750 of FIG. 7). The data plane DMZ tier 1048 can include LB subnet(s) 1022 that can be communicatively coupled to trusted app subnet(s) 1060 (e.g. trusted app subnet(s) 960 of FIG. 9) and untrusted app subnet(s) 1062 (e.g. untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g. public Internet 754 of FIG. 7).

The Internet gateway 1034 contained in the control plane VCN 1016 and contained in the data plane VCN 1018 can be communicatively coupled to a metadata management service 1052 (e.g. the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

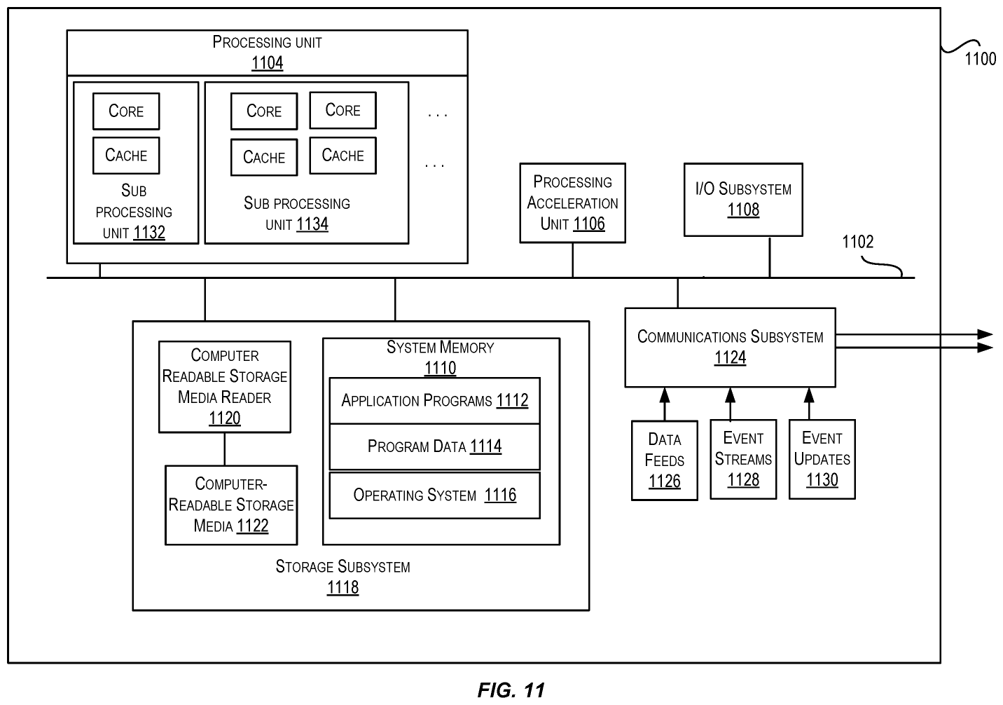

FIG. 11 illustrates an example computer system 1100, in which various embodiments of the present disclosure may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 15 OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118. These software modules or instructions may be executed by processing unit 1104. Storage subsystem 1118 may also provide a repository for storing data used in accordance with the present disclosure.

Storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

What is claimed is:

1. A method comprising:
receiving data for use in generation of a machine learning model output;
ingesting the data with a first machine learning model on a Graphic Processing Unit (“GPU”);
receiving at least one intermediate output from the first machine learning model at a temporary store;
receiving the at least one intermediate output from the temporary store at a Central Processing Unit (“CPU”);
ingesting the at least one intermediate output with a second machine learning model on the CPU; and
outputting a prediction with the second machine learning model.

2. The method of claim 1, wherein the first model comprises a first neural network, and wherein the second model comprises a second neural network.

3. The method of claim 2, wherein the first neural network comprises a deep learning neural network.

4. The method of claim 3, wherein the deep learning neural network comprises a transformer.

5. The method of claim 4, wherein the transformer comprises a Bidirectional Encoder Representations from Transformers (“BERT”) model.

6. The method of claim 3, wherein the second machine learning model comprises a task specific model.

7. The method of claim 1, wherein the at least one intermediate output comprises a plurality of intermediate outputs, each of the plurality of intermediate outputs generated by a unique layer of the first machine learning model.

8. The method of claim 7, wherein an intermediate output is received at the CPU from the temporary store for each of the second layers of the second machine learning model.

9. The method of claim 7, further comprising:
identifying a next layer in the second model;
receiving the intermediate output corresponding to the next layer; and
generating a layer output of the identified next layer based at least in part on the corresponding intermediate output.

10. The method of claim 9, further comprising:
identifying at least one previous layer in the second model; and
receiving a layer output of the identified at least one previous layer.

11. The method of claim 10, wherein receiving the layer output of the at least one previous layer comprises receiving the layer output of the layer immediately preceding the identified next layer.

12. The method of claim 10, wherein receiving the layer output of the at least one previous layer comprises receiving the layer output of the two layers immediately preceding the identified next layer.

13. The method of claim 10, further comprising combining the intermediate output corresponding to the next layer and the layer output of the identified at least one previous layer.

14. The method of claim 13, wherein generating the layer output of the identified next layer based at least in part on the corresponding intermediate output comprises generating the layer output based on the combined intermediate output corresponding to the next layer and the layer output of the identified at least one previous layer.

15. The method of claim 10, further comprising:
receiving the layer output of a last layer in the second model; and
ingesting the layer output of the last layer into a classifier head.

16. The method of claim 15, further comprising generating the output prediction with the classifier head based on the ingested layer output of the last layer.

17. The method of claim 1, further comprising:
receiving the at least one intermediate output from the temporary store at a second Central Processing Unit (“second CPU”);
ingesting the at least one intermediate output with a third machine learning model on the second CPU; and
outputting a prediction with the third machine learning model.

18. The method of claim 17, wherein the third machine learning model comprises only a classifier head.

19. A system comprising:
memory comprising a temporary store;
a Graphics Processing Unit machine running a first machine learning model, wherein the Graphics Processing Unit machine is configured to:
receive data for use in generation of a machine learning model output;
ingest the data with the first machine learning model;
generate at least one intermediate output from the first machine learning model; and
provide the at least one intermediate output to the temporary store;
a Central Processing Unit machine running a second machine learning model, wherein the Central Processing Unit machine is configured to:
receive the at least one intermediate output from the temporary store;
ingest the at least one intermediate output with the second machine learning model; and
output a prediction with the second machine learning model.

20. A non-transitory computer-readable storage medium storing a plurality of instructions executable by one or more processors, the plurality of instructions when executed by the one or more processors cause the one or more processors to:
receive data for use in generation of a machine learning model output;
ingest the data with a first machine learning model on a Graphic Processing Unit machine;
receive at least one intermediate output from the first machine learning model at a temporary store;
receive the at least one intermediate output from the temporary store at a Central Processing Unit machine;
ingest the at least one intermediate output with a second machine learning model on the Central Processing Unit machine; and
output a prediction with the second machine learning model.
